(19) United States
(12) Patent Application Publication
(10) Pub. No.: US 2007/0224896 A1
(43) Pub. Date: Sep. 27, 2007

(54) Natural polymer mat and method for manufacturing the same

(76) Inventor: Su-Tuan Hsu Tang, Taoyuan County (TW)

Correspondence Address: HSU TANG, SU-TUAN, P.O. Box 44 - 2049, Taipei, 10668, TW

(21) Appl. No.: 11/385,811

(22) Filed: Mar. 22, 2006

(51) Int. Cl. B05D 3/02; B05D 1/36; B32B 5/02

(52) U.S. Cl. 442/59; 427/374.1; 427/412

(57) ABSTRACT

The present invention discloses a natural polymer mat and a method for manufacturing the same, particularly a mat that can be biologically degenerated and its manufacturing method. The method includes the steps of (a) providing and leveling a central meshed fabric and continuously outputting the central meshed fabric; (b) using a material feeder that contains a natural polymer material to coat the natural polymer material with a predetermined composition onto the leveled central meshed fabric; (c) providing a predetermined high temperature to dry the natural polymer material; and (d) providing an instant temperature drop to condense the natural polymer material, wherein the natural polymer material is composed of a large proportion of natural polymer material, a yeast, a small proportion of pure water, a small amount of resin, and a small amount of cross-linking agent for producing a natural polymer mat.

### BACKGROUND OF THE INVENTION

1. Field of the Invention

The present invention relates to a natural polymer mat and a method for manufacturing the same, and more particularly to a mat and a method for manufacturing the same that use a natural polymer material to substitute traditional plastics as a filler, so that after the mat is discarded, the nutrient sources of the mat and the microorganisms in the soil are used for the biological degeneration of the discarded mat.

2. Description of the Prior Arts

Although the industrial society constantly brings tremendous convenience to our life, yet the extensive use of plastics come from the petrochemistry and the huge amount of plastic garbage become a secret worry and create pollution to our environment. As indicated in a survey conducted by the Gallup Organization, the quantity of solid trashes produced by cities in the United States in 2000 reaches up to 216,000,000 tons, wherein the discarded plastics occupy 9.8% of the total trashes (and over 30% of the total by volume), and Taiwan also produces plastic trashes exceeding 15% of the total trashes. These statistics show that plastic is definitely a major damage to our ecological environment.

As to the present mat manufacturing technologies, almost all plastics contaminate the environments, and these plastics include polyvinyl chloride (PVC) or plasticizers such as di-iso-nonyl phthalate (DINP) di-octyl phthalate (DOP), dioctyl adipate (DOA), azo dyes, cadmium, vinyl chloride monomer (VCM), nonylpheno, and organic tin, which can be used for manufacturing mats such as an anti-slippery mat, an anti-slippery net, an exercise mat, etc. Since these mats contain the aforementioned toxic plastics and become one of the environmental pollutants, therefore finding a way of designing a mat that contains no plastic but has the properties of plastic to meet the requirements of the environmental protection demands immediate attention and feasible solutions.

### SUMMARY OF THE INVENTION

In view of the shortcomings of the prior art, the inventor of the invention based on years of experience in the related industry to conduct extensive researches and experiments, and finally invented a natural polymer mat and method for manufacturing the same in accordance with the invention.

Therefore, it is a primary objective of the present invention to provide a natural polymer mat and a method for manufacturing the same, and the method uses a natural polymer material to substitute a plastic material as a filler and goes through a special process to manufacture a mat that contains no plastic material and meets the requirements for environmental protection as well as having the properties of a plastic material.

The present invention provides a method for manufacturing a natural polymer mat that comprises the steps of (a) providing and leveling a central meshed fabric, and continuously outputting the central meshed fabric; (b) using a material feeder that contains the natural polymer material to coat the natural polymer material with a predetermined composition onto the leveled central meshed fabric; (d) providing a predetermined high temperature to dry the natural polymer material; and (d) providing an instant temperature drop to condense the natural polymer materi al, and produce a natural polymer mat.

The present invention provides a natural polymer mat that comprises a central meshed fabric having an upper surface and a lower surface, and a natural polymer material layer disposed on at least one of the upper and lower surfaces of the central meshed fabric, and the natural polymer material is made according to a predetermined composition, and the predetermined composition contains a large proportion of natural polymer material, a yeast, a small proportion of pure water, a small quantity of resin, and a small amount of cross-linking agent.

### BRIEF DESCRIPTION OF THE DRAWINGS

The present invention will now be described in more detail hereinafter with reference to the accompanying drawings that show various embodiments of the invention, in which:

FIG. 1 is a schematic view of manufacturing a natural polymer mat according to a method of the present invention;

FIG. 2 is a schematic perspective view of manufacturing a natural polymer mat according to a method of the present invention; and

FIG. 3 is a flow chart of a method for manufacturing a natural polymer mat according to the present invention.

### DETAILED DESCRIPTION OF THE PREFERRED EMBODIMENTS

The present invention provides a natural polymer mat and a method for manufacturing the same that uses a meshed fabric as a support framework, and then coats the natural polymer material made by a predetermined composition onto the exterior of the meshed fabric and finally goes through a pressing by force, a high-temperature drying, and a condensation with an instant temperature drop to produce the natural polymer mat.

Since the polymer material used in the invention includes a natural polymer such as pectin, cellulose and starch, etc, the polymer material does not have the high plasticity of the plastics and the control of physical properties and applicability of the finished goods cannot match with those of the plastics. Thus, it is necessary to change or convert the physical properties or strictly set and control the manufacturing process to produce a natural polymer mat (including the extensively used mat such as an anti-slippery mat, an anti-slippery net, or an exercise mat, etc) of the present invention.

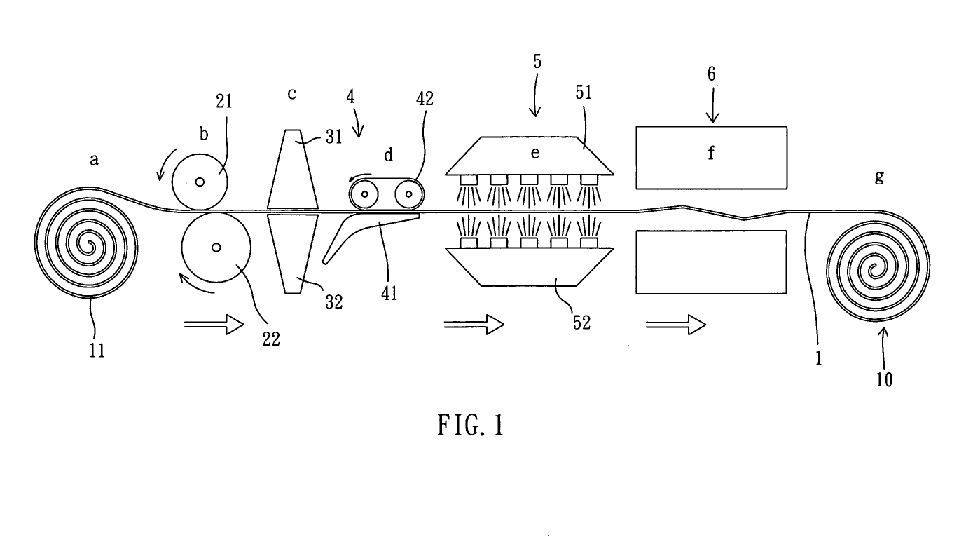

Referring to FIG. 1 for the schematic view of manufacturing a natural polymer mat 1 in accordance with the present invention., the method of manufacturing the natural polymer mat 1 comprises the steps of: (a) providing and leveling a central meshed fabric 11, and continuously outputting the central meshed fabric 11, wherein the fiber or tissue composition of the central meshed fabric 11 contains natural plant fibers such as hemp, bamboo (bamboo charcoal) and cotton, natural polymers or polymers; (b) providing at least two rollers 21, 22 disposed separately at an upper and a lower positions, and the two rollers 21, 22 rotate in opposite directions, and the central meshed fabric 11 passes between the two rollers 21, 22 while pressing the two rollers 21, 22, so as to achieve the effect of sending the central meshed fabric 11; (c) using upper and lower material feeders 31, 32 containing the natural polymer material to coat the natural polymer material 12 with a predetermined composition on at least one of the upper or lower surfaces of the central meshed fabric 11 and forming a semi-finished goods on at least one of the upper and lower surfaces of the leveled central meshed fabric 11; wherein the upper or lower roller 21, 22 is connected and operated with the upper or lower material feeder 31, 32 to carry out a coating of the natural polymer material 12 on one surface of the central meshed fabric 11; (d) providing a pressing roller platform 4 to pass the semi-finished goods of the central meshed fabric 11 of the natural polymer material through, so as to achieve the effect of leveling the central meshed fabric 1, and the pressing roller platform 4 compresses a level 41 and a transmission belt 42 closely attached to the level 41, and the semi-finished goods are clamped between the level 41 and the transmission belt 42 for the transmission; (e) providing a high-temperature area 5 at a predetermined high temperature to dry the natural polymer material, and the high-temperature area 5 includes a plurality of high-temperature units 51, 52 disposed on at least one of the upper and lower surfaces of the semi-finished goods, and the high-temperature unit 51, 52 could be a hot wind system or electric heat pipe system, and the predetermined high temperature is controlled substantially at 220° C.; (f) providing a low-temperature area 6 with an instant temperature drop to condense the natural polymer material, and the low temperature area 6 provides a predetermined low temperature substantially ranging from 5° C. to 8° C. to produce a natural polymer mat 1; and (g) rolling the condensed natural polymer mat 1 to form a rolling type natural polymer mat 10.

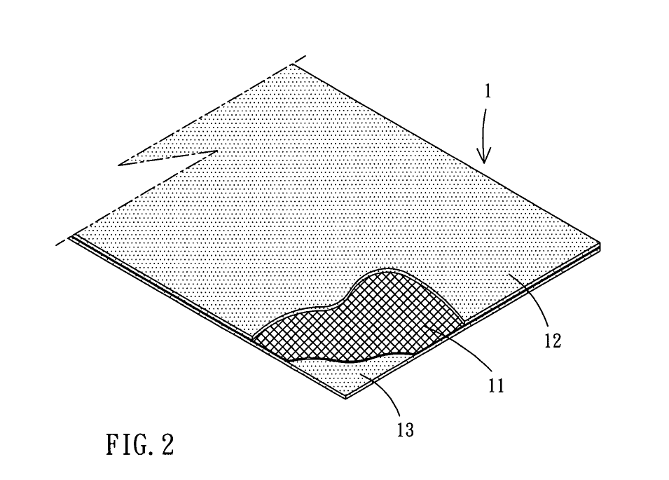

In FIG. 2, the natural polymer mat 1 comprises a central meshed fabric 11 having upper and lower surfaces, and a natural polymer material layer 12, 13 disposed on at least one surface of the upper and lower surfaces of the central meshed fabric 11, wherein the natural polymer material layer 12, 13 is made according to a predetermined composition, and the predetermined composition contains a large proportion of natural polymer material, a yeast, a small proportion of pure water, a small quantity of resin, and a small amount of cross-linking agent.

The composition of the natural polymer mat 1 includes a large proportion (substantially equal to 70%) of the natural polymer material (such as pectin, cellulose, or starch), a small amount (substantially equal to 1%) of yeast, a small amount (substantially equal to 20%) of pure water and these substances are well mixed (Step 1). Then, a small amount (substantially equal to 5%) of resin is added, wherein the resin could be a polyol cross-linked with Isocyanate, acrylic resin, or polyisoprene (Step 5). A small amount (substantially equal to 4%) of cross-linking agent is added, wherein the cross-linking agent is a water-soluble polymer such as methylethycellulose with modified starch or stadex material, and they are well mixed (Step 6).

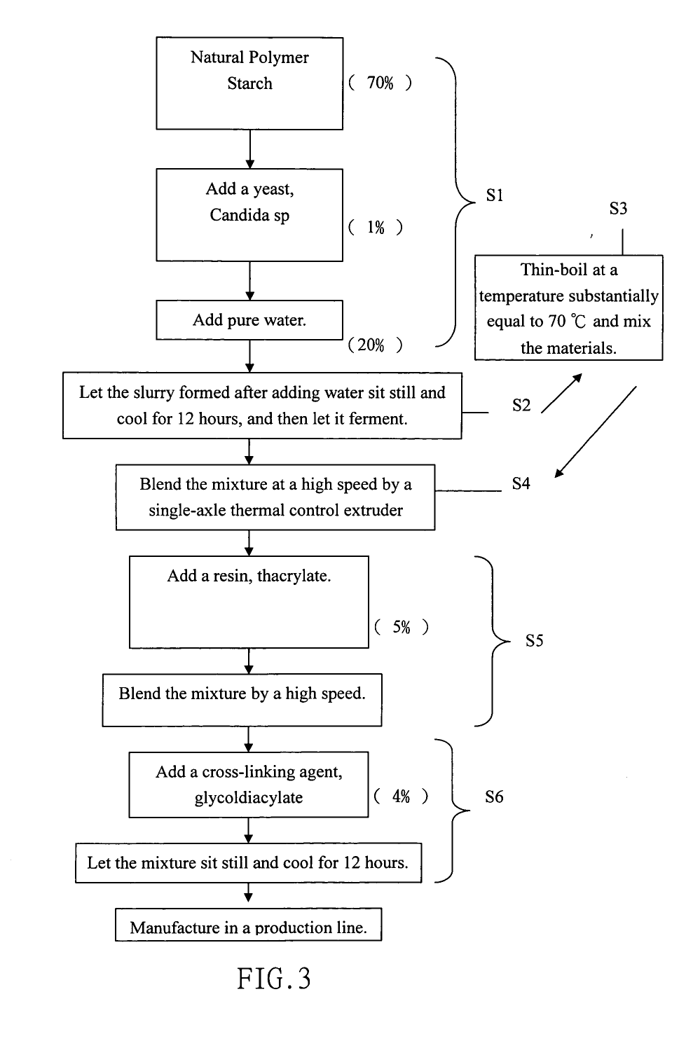

Referring to FIG. 3 for the flow chart of the method for manufacturing a natural polymer according to the present invention, the method comprises the steps of preparing a natural polymer mat with the composition that contains a large proportion of natural polymer material, a small amount of yeast, and a small amount of pure water (Step S1); letting the foregoing materials sit still for a long while (approximately 12 hours), cool down and ferment (Step S2); thin-boiling the foregoing materials at a temperature substantially at 70° C. to obtain a high plasticity or a high viscosity (Step S3); blending the foregoing materials at a high speed by a single-axle temperature control extruder and evenly mixing the foregoing materials for a short while (approximately 2 hours) (Step S4); adding a small amount of resin, and the resin could be a polyol cross-linked with Isocyanate, acrylic resin, or polyisoprene, and blended at a high speed (Step S5); adding a small amount of cross-linking agent after the foregoing materials are well mixed, and the cross-linking agent has emulsifying and stabilizing functions, and the cross-linking agent is a water-soluble polymer such as methylethycellulose with modified starch or stadex, and letting the foregoing materials sit and cool down for 12 hours (Step S6), so as to produce the natural polymer material.

In summation of the description above, the natural polymer mat and method for manufacturing the same in accordance with the invention have the following effects:

1. The mat of the invention uses the natural polymer material (pectin, cellulose, or starch) as the main filling materials to maintain the same functions and applicability of the general plastic products.

2. The mat of the invention contains the natural polymer material as the main filling material, and thus it contains no plastic at all and it is suitable for a use of a direct contact with human skins.

3. The mat of the invention contains the natural polymer material as the main filling material, so that after the mat is discarded, the nutrients of the natural polymer material and the microorganisms in the nature carry out the biological degeneration to produce a compound (and dreg) with a low molecular weight, and finally the natural polymer material will be degenerated into inorganic matters such as carbon dioxide and water to be absorbed by the environment. Thus the mat of the invention fully complies with the requirements of environmental protection.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing a natural polymer mat, comprising the steps of:
providing and leveling a central meshed fabric, and continuously outputting said central meshed fabric;
using a material feeder that contains a natural polymer material to coat said natural polymer material with a predetermined composition onto a meshed fabric;
providing a predetermined high temperature to dry said natural polymer material; and
providing an instant temperature drop to condense said natural polymer material and produce a natural polymer mat;
wherein said predetermined composition consists of a large proportion of natural polymer material, a yeast, a small proportion of pure water, a small quantity of resin, and a small amount of cross-linking agent.

2. The method of claim 1, wherein said step of leveling said central meshed fabric further comprises the step of providing at least two rollers disposed separately at upper and lower positions, and said central meshed fabric passes between said two rollers and presses against said two rollers, so as to achieve the effect of conveying said central meshed fabric.

3. The method claim 1, wherein said step of leveling said central meshed fabric further comprises the step of providing a pressing roller platform to pass said central meshed fabric coated with said natural polymer material through said pressing roller platform, so as to achieve the effect of leveling said central meshed fabric.

4. The method of claim 1, wherein said step of coating said natural polymer material further comprises the step of disposing said natural polymer material onto both top and bottom surfaces of said central meshed fabric.

5. The method of claim 1, wherein said step of coating said natural polymer material further comprises the step of coating said natural polymer material onto one of the surfaces of said central meshed fabric.

6. The method of claim 1, wherein said step of preparing said determined composition of said natural polymer material further comprising the steps of:
preparing said composition according to a large proportion of said natural polymer material, a small amount of said yeast, and a small proportion of said pure water;
allowing said natural polymer material to sit still for a long while, cool, and ferment;
evenly mixing said materials for a short while, and then adding a small amount of said resin;
adding a small amount of said cross-linking agent after evenly mixing said materials; and
allowing said materials to sit still; so as to manufacture said natural polymer material.

7. The method of claim 6, wherein said step of allowing said natural polymer material to sit for a long while further comprises the step of thin-boiling said mixed material substantially at a temperature of 70° C., so as to achieve a high plasticity of said mixed material.

8. The method of claim 6, wherein said long while and said short while are equal to 12 hours and 2 hours respectively, and said composition is prepared by a single-axle temperature control extruder at a high speed.

9. The method of claim 6, wherein said step of mixing said cross-linking agent further comprises the step of allowing said materials to cool for 12 hours.

10. The method of claim 1, wherein said step of drying said natural polymer material further comprises the step of drying said natural polymer material at a predetermined high temperature substantially at 220° C.

11. The method of claim 1, wherein said step of condensing said natural polymer material further comprising the step of condensing said natural polymer material at a predetermined low temperature substantially ranging from 5° C. to 8° C.

12. The method of claim 1, wherein said step of condensing said natural polymer material further comprising the later step of rolling up said condensed natural polymer mat, so as to form a rolling type natural polymer mat.

13. The method of claim 1, wherein said natural polymer material contains natural polymers including pectin, cellulose or starch.

14. The method of claim 1, wherein said resin is formed by cross-linking polyol with Isocyanate.

15. The method of claim 1, wherein said resin is formed by cross-linking polyol with Isocyanate and acrylic resin.

16. The method of claim 1, wherein said resin is formed by cross-linking polyol with Isocyanate and polyisoprene.

17. The method of claim 1, wherein said cross-linking agent contains a water-soluble polymer with a modified starch or a stadex material.

18. The method of claim 17, wherein said water-soluble polymer contains methylethycellulose.

19. The method of claim 1, wherein said predetermined composition includes substantially 70% of natural polymer material, substantially 1% of yeast, substantially 20% of pure water, and substantially 5% of resin.

20. The method of claim 1, wherein the composition of a fiber tissue of said central meshed fabric contains natural plant fibers including hemp, bamboo (bamboo charcoal), and cotton or polymers.

21. The natural polymer mat manufactured by the method of claim 1, comprising:
a central meshed fabric, having an upper surface and a lower surface; and
a natural polymer material layer, disposed on at least one of said upper and lower surface of said central meshed fabric;
wherein said natural polymer material layer is formed according to a predetermined composition that contains a large proportion of natural polymer material, a yeast, a small proportion of pure water, a small quantity of resin, and a small amount of cross-linking agent.
